(19) United States
(12) Patent Application Publication
(10) Pub. No.: US 2009/0307770 A1
(43) Pub. Date: Dec. 10, 2009

(54) APPARATUS AND METHOD FOR PERFORMING INTEGRITY CHECKS ON SOFWARE

(76) Inventors: Peter William Harris, Cambridge (GB); Peter Brian Wilson, Cambridge (GB)

Correspondence Address: NIXON & VANDERHYE, PC, 901 NORTH GLEBE ROAD, 11TH FLOOR, ARLINGTON, VA, 22203, US

(21) Appl. No.: 12/309,915

(22) PCT Filed: Aug. 17, 2006
(86) PCT No.: PCT/GB2006/003088

§ 371 Date: Feb. 3, 2009

(51) Int. Cl. G06F 11/36

(52) U.S. Cl. 726/22; 714/38; 714/45; 714/E11.208; 714/E11.212

(57) ABSTRACT

An apparatus and method are provided for performing integrity checking of software code executing on a processing unit of the apparatus. The apparatus further includes debug logic used when debugging program code executed by the processing unit, and trusted logic for performing trusted integrity checking operations on less-trusted program code executed by the processing unit. The debug logic has an interface via which the trusted logic can program one or more control registers, that interface not being accessible by the less-trusted program code. The trusted logic programs the control registers so as to cause the debug logic to be re-used to detect one or more activities of the processing logic during execution of the less-trusted program code, and the trusted integrity checking operations performed by the trusted logic are influenced by the activities detected by the debug logic. Such an approach has been found to provide an efficient and secure technique for performing run-time integrity checking of program code.

### FIELD OF THE INVENTION

The present invention relates to an apparatus and method for performing integrity checks on software, and in particular to techniques for performing run-time integrity checking of such software whilst it is executing.

### BACKGROUND OF THE INVENTION

Integrity checking of software is a technique used to implement security countermeasures. The actual checks performed can take a variety of forms, but the aim of such checks is to ensure that the software code that is executing is that which is expected (i.e. it has not been tampered with), and that that code is being called in the proper manner (i.e. the code around the area(s) being checked has not been tampered with). In particular, run-time integrity checking of code guards against malicious modification of code or data by internal attacks (i.e. exploiting software faults) or external attacks (i.e. hardware attacks).

One type of integrity checking procedure involves performing static cryptographic hashes of regions of code being executed. If a code region is tampered with then it will not produce the same cryptographic hash when it is next checked, indicating that something is wrong. Another type of integrity checking procedure involves dynamic “semantic” (also known as “heuristic”) checks of key points in the code being executed. If code is used out of sequence, or in an atypical manner, then semantic checks can be used to detect this and take appropriate action. Yet another type of integrity checking procedure that can be performed is function gating, where the software (or individual functions thereof) can only be accessed through one or more predefined entry points or gates. If a function is entered without coming through the appropriate gate, an error has occurred, and can be trapped in the software or hardware. Some function gate techniques require support in the core hardware (x86 has some support for creating these), whilst others can be constructed in software.

Current implementations of integrity checking techniques are either done entirely in software, or require custom hardware blocks external to the processing unit executing the code being checked. Existing software-only approaches to run-time integrity checking require invasive changes to the software being checked, which it is impossible to ensure the security of (since hacked software cannot check itself), and high bandwidth cryptographic hashes of critical code running. Since the software executing the hash checking has no idea which critical piece of code is going to run next, it has to check everything in a statistical fashion, either resulting in a system with poor performance (due to checking too much or checking too often), or a system with weaker security (due to checking less often or checking less code to reduce performance overhead).

Considering the alternative option of using custom hardware outside of the processing unit executing the code, such an approach is expensive to implement, may have restricted configurability, and will not typically have access to signals internal to the processing unit to enable a strong, robust check to be performed.

From the above discussion, it will be appreciated that run-time integrity checking in a secure manner is difficult to achieve, and often relies on custom hardware, or hard to enforce software policies. Accordingly, it would be desirable to provide an improved technique for performing run-time integrity checking of code being executed by a processing unit of a data processing apparatus.

### SUMMARY OF THE INVENTION

Viewed from a first aspect, the present invention provides a data processing apparatus comprising: a processing unit operable to execute program code; debug logic for use when debugging the program code executed by the processing unit; trusted logic operable to perform trusted integrity checking operations on less-trusted program code executed by the processing unit; the debug logic having an interface via which one or more control registers associated with the debug logic are programmable by the trusted logic, the interface not being accessible by the less-trusted program code; the trusted logic being operable to program the one or more control registers to cause the debug logic to be re-used to detect one or more activities of the processing logic during execution of said less-trusted program code; the trusted integrity checking operations performed by the trusted logic being influenced by the activities detected by the debug logic.

In accordance with the present invention, debug logic already provided within the data processing apparatus for debugging program code executed by the processing unit is re-used to detect one or more activities of the processing logic during execution of certain less-trusted program code, with the activities detected by the debug logic then being used to influence trusted integrity checking operations performed by the data processing apparatus. In particular, trusted logic is provided to perform trusted integrity checking operations on less-trusted program code executed by the processing unit, and the debug logic is provided with an interface through which one or more control registers can be programmed by the trusted logic, that interface not being accessible by the less-trusted program code.

It has been found that such an approach provides a much more efficient and secure technique for performing run-time integrity checking within a data processing apparatus. In particular, by re-using existing debug logic within the data processing apparatus, the solution is relatively cheap to implement. Further, since the debug logic is programmed by the trusted logic through an interface that is not accessible by the less-trusted program code, the integrity checking process is more secure than prior art software based solutions. Additionally, the debug logic will typically have access to signals occurring within the processing unit, and hence can facilitate strong and robust integrity checking processes.

Furthermore, as mentioned earlier, some types of integrity checking procedures, for example semantic checking of code, is normally performed via invasive software patches, which malicious software can potentially work around. By allowing the debug hardware to monitor and detect key points of execution, this removes the need to invasively modify the software to be monitored, thereby increasing the security, effectiveness and speed of the trusted integrity checking operations.

The trusted logic can take a variety of forms, and for example may be provided by a separate processor to the processing unit executing the program code being checked. Alternatively, the trusted logic may be provided by the processing unit itself, for example by the processing unit when operating in one or more particular privileged modes of operation.

As another example of how the trusted logic may be formed, one technique that has been developed to seek to alleviate the reliance on operating system security is to provide a system in which the data processing apparatus is provided with separate domains, these domains providing a mechanism for handling security at the hardware level. Such a system is described for example in commonly assigned co-pending U.S. patent application Ser. No. 10/714,561, the contents of which are herein incorporated by reference, this application describing a system having a secure domain and a non-secure domain. In that system, the non-secure and secure domains in effect establish separate worlds, the secure domain providing a trusted execution space separated by hardware enforced boundaries from other execution spaces, and likewise the non-secure domain providing a non-trusted execution space. In such embodiments, the trusted logic may be arranged to operate in a secure domain to perform the trusted integrity checking operations.

Whilst the present invention allows the debug logic to be re-used as described above, the debug logic will still typically be able to be used for standard debugging operations. Hence, the debug logic may for example be accessed via one or more further interfaces by certain software processes executing on the processing unit, whether trusted or non-trusted software, or indeed by an external debugger session. In a system employing secure and non-secure domains, this external debugger may operate in the secure domain or the non-secure domain. In any event the one or more control registers controlling the re-use of the debug logic for integrity checking purposes are only programmable by the trusted logic via the associated interface.

There are a number of ways in which the activities detected by the debug logic can be used to influence the trusted integrity checking operations performed by the trusted logic. In one embodiment, upon occurrence of one or more predetermined conditions the debug logic is operable to issue a signal to the trusted logic to cause one or more of said trusted integrity checking operations to be performed. In one particular embodiment, this signal will take the form of an exception signal which triggers the trusted logic to perform one or more trusted integrity checking operations. Hence, by such an approach, the debug logic can be arranged to immediately trigger trusted integrity checking operations upon occurrence of one or more predetermined conditions.

These predetermined conditions can take a variety of forms. In one embodiment, at least one of those predetermined conditions is the detection of a predetermined activity of the processing logic by the debug logic. Accordingly, in such instances, upon detection of certain particularly suspect activities, the debug logic can be arranged to immediately issue a signal to the trusted logic to invoke one or more integrity checking operations. As another example of the predetermined conditions that can cause the debug logic to issue the signal, the debug logic can be arranged to maintain information about the activities detected, and one of the predetermined conditions may be the volume of that maintained information reaching a threshold value. Hence, in such embodiments, the debug logic can log information about the activities detected, and once that volume of information reaches a certain level, can then trigger the integrity checking operations to be performed by the trusted logic.

There are a number of ways in which the maintained information can be used by the trusted logic. In one embodiment, the maintained information is used by the trusted logic to determine which of the trusted integrity checking operations to perform. Alternatively, or in addition, the trusted integrity checking operations may be performed on the maintained information, rather than on the program code itself.

The debug logic can take a variety of forms. For example, in one embodiment the debug logic may comprise one or more watchpoint registers which can be set to identify activities which on detection by the debug logic should cause a signal to be issued to the trusted logic. However, in one embodiment, the debug logic comprises trace generation logic for producing a stream of trace elements indicative of activities of the processing logic for use when debugging the program code executed by the processing logic, the trusted logic being operable to re-use the trace generation logic to maintain information about said one or more activities detected during execution of the less-trusted program code by the processing logic, said maintained information being used to influence the trusted integrity checking operations performed by the trusted logic.

Such trace logic is typically provided within a data processing apparatus to perform tracing operations when debugging the data processing apparatus, such tracing operations often being referred to as non-invasive debug operations since they do not require any modification to the program code being executed by the processing unit. In accordance with this embodiment of the present invention, such trace logic is re-used to detect activities, and maintain information about those activities, during execution of the less-trusted program code, with the activities to be detected being programmed into the trace logic by the trusted logic, and with the activities detected by the trace logic then being used to influence the trusted integrity checking operations performed by the trusted logic.

In embodiments where the debug logic comprises trace generation logic, that debug logic may further comprise a trace buffer into which the maintained information is stored. In one embodiment, this trace buffer will be provided on the same chip as the processing unit and the debug logic.

The maintained information can take a variety of forms. However, in one embodiment, the maintained information comprises a log for each of the one or more activities detected. If the same type of activity is detected multiple times, then the log for that activity may be updated by the debug logic and that updated log may be output, for example to a trace buffer, each time it is updated, or periodically.

The activities that the debug logic may be programmed to detect can take a variety of forms. However, in one embodiment, at least one of those activities comprises access by the processing logic to a specified memory address range programmed into the one or more control registers by the trusted logic.

In one embodiment, the data processing apparatus has a plurality of domains in which devices of the data processing apparatus can execute, the processing logic being operable in a non-secure domain to execute said less-trusted program code, and the trusted logic being operable in a secure domain to perform said trusted integrity checking operations. In one such embodiment, the processing logic is further operable in said secure domain, and said trusted logic is formed by said processing logic executing trusted integrity checking code in said secure domain.

In one such embodiment, the processing logic is operable in a plurality of modes, including at least one non-secure mode being a mode in the non-secure domain and at least one secure mode being a mode in the secure domain. Typically one or more of the modes will be replicated in each domain, and hence by way of example there may be a non-secure user mode and a secure user mode, a non-secure supervisor mode and a secure supervisor mode, etc.

Hence, whilst the secure domain and the non-secure domain provide separate execution spaces separated by hardware enforced boundaries, different modes of operation can also be provided for the processing logic. Such modes of operation are typically controlled by the operating system applicable to the processing unit when executing in a particular domain.

In one such embodiment, in the non-secure domain said processing logic is operable under the control of a non-secure operating system, and in said secure domain said processing logic is operable under the control of a secure operating system. Hence, in such embodiments different operating systems are used within the processing logic, dependent on the domain that the processing logic is executing in. The secure operating system will typically be significantly smaller than the non-secure operating system and can be viewed as a secure kernel provided to control certain secure functions.

In one embodiment, even where multiple domains are not used, the processing logic may be operable in a plurality of modes, and in particular may operate in at least one less-trusted mode to execute the less-trusted program code, whilst the trusted logic then operates in a trusted mode to execute trusted integrity checking code. The trusted mode may take a variety of forms, but in one embodiment the trusted mode is at least one privileged mode. In such embodiments, the less-trusted mode may be a user mode, or indeed may be a less-trusted privileged mode.

If in addition the data processing apparatus has a plurality of domains then in some embodiments the trusted mode may be at least one of the secure modes associated with the secure domain. If for example the trusted mode is a particular secure privileged mode, then the less-trusted mode in which the less-trusted program code is executed may be a less-trusted secure mode, for example a secure user mode, or alternatively could be any of the non-secure modes, which will all be less-trusted than the secure mode. In one embodiment, the trusted logic is formed by the processing logic executing in the trusted mode, but alternatively the trusted logic may be provided by a separate processor to the processing logic.

Viewed from a second aspect, the present invention provides a data processing apparatus comprising: processing means for executing program code; debug means for use when debugging the program code executed by the processing means; trusted means for performing trusted integrity checking operations on less-trusted program code executed by the processing means; the debug means having interface means via which one or more control register means associated with the debug means are programmable by the trusted means, the interface means not being accessible by the less-trusted program code; the trusted means programming the one or more control register means to cause the debug means to be re-used to detect one or more activities of the processing means during execution of said less-trusted program code; the trusted integrity checking operations performed by the trusted means being influenced by the activities detected by the debug means.

Viewed from a third aspect, the present invention provides a method of operating a data processing apparatus to perform integrity checking operations, the data processing apparatus having a processing unit for executing program code, and debug logic for use when debugging the program code executed by the processing unit, the method comprising the steps of: employing trusted logic to perform trusted integrity checking operations on less-trusted program code executed by the processing unit; programming one or more control registers of the debug logic via an interface which is not accessible by the less-trusted program code, said programming causing the debug logic to be re-used to detect one or more activities of the processing logic during execution of said less-trusted program code; and performing the trusted integrity checking operations dependent on the activities detected by the debug logic.

### BRIEF DESCRIPTION OF THE DRAWINGS

The present invention will be described further, by way of example only, with reference to embodiments thereof as illustrated in the accompanying drawings, in which:

FIG. 1 is a block diagram of a known data processing system including an on-chip trace module;

FIG. 2 is a diagram schematically illustrating how the on-chip trace module and associated trace buffer can be re-used in accordance with one embodiment of the present invention to assist in performing integrity checking operations;

FIG. 3 is a diagram illustrating in more detail the on-chip trace module of FIG. 2;

FIGS. 4A and 4B are flow diagrams illustrating a sequence of activities that may be performed in accordance with one embodiment of the present invention to use the on-chip trace module to influence integrity checking operations;

FIG. 5 is a flow diagram illustrating the operation of the control logic of FIG. 3 in accordance with one embodiment of the present invention;

FIG. 6 is a flow diagram illustrating the operation of the trace generator of FIG. 3 in accordance with one embodiment of the present invention;

FIG. 7 is a diagram schematically illustrating the fields that may be provided within each log produced by the trace generator of FIG. 3 in accordance with one embodiment;

FIG. 8 schematically illustrates different programs operating in a non-secure domain and a secure domain;

FIG. 9 schematically illustrates a matrix of processing modes associated with different security domains; and

FIGS. 10 and 11 schematically illustrate different relationships between processing modes and security domains.

### DESCRIPTION OF EMBODIMENTS

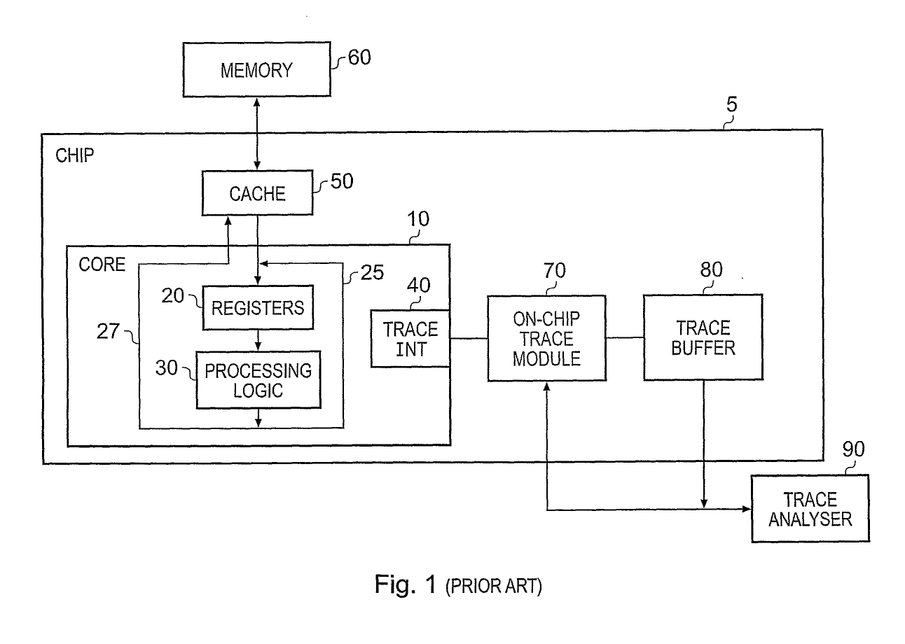

FIG. 1 schematically illustrates a known data processing system providing debug logic in the form of an on-chip trace module. In particular, an integrated circuit 5 such as a System-on-Chip (SoC) includes a processor core 10, a cache memory 50, an on-chip trace module 70 and a trace buffer 80. Whilst in FIG. 1 the trace buffer 80 is shown as being provided on-chip, in alternative embodiments this trace buffer is provided off-chip with a bus interconnecting the trace buffer 80 with the output from the on-chip trace module 70. Further, in some embodiments, at least part of the trace module 70 may also be provided off-chip.

Within the processor core 10 is provided a register bank 20 containing a number of registers for temporarily storing data. Processing logic 30 is also provided for performing various arithmetical or logical operations on the contents of the registers. Following an operation by the processing logic 30, the result of the operation may be either recirculated into the register bank 20 via the path 25 and/or stored in the cache 50 over the path 27. Data can also be stored in the registers 20 from the cache 50.

The SoC 5 is connected to memory 60 which is accessed when a cache miss occurs within the cache memory 50. It will be appreciated that the memory 60 may actually consist of a number of different memory devices arranged to form a number of hierarchical levels of memory, and whilst the memory 60 is shown as being provided off-chip, one or more of these levels of memory may in fact be provided on-chip.

It will also be appreciated that the presence of the cache 50 is optional, and in some implementations no cache may be present between the core 10 and the memory 60.

A trace analyser 90, which may in one embodiment be formed by a general purpose computer running appropriate software, is coupled to the on-chip trace module 70 and the trace buffer 80. The on-chip trace module 70 is arranged to receive via a trace interface 40 of the processor core 10 information about the sequence of operations performed by the processor core, and dependent thereon produces a stream of trace elements which are stored in the trace buffer 80. The trace analyser 90 is then used to analyse that stream of trace elements in order to derive information used during debugging of the processor core. In particular, through analysis of the stream of trace elements, the step-by-step activity of the processor core can be determined, which is useful when attempting to debug sequences of processing instructions being executed by the processor core.

The trace analyser 90 is connected to the on-chip trace module 70 to enable certain features of the on-chip trace module to be controlled by the user of the trace analyser. Additionally in some embodiments, the stream of trace elements produced by the on-chip trace module may be provided directly to the trace analyser 90 rather than being buffered in the trace buffer 80.

The above description is provided to illustrate the known use of an on-chip trace module 70 in association with a trace analyser 90 to perform debug operations on instructions executed by the processor core 10. As will now be discussed in detail below, in accordance with embodiments of the present invention, the on-chip trace module is arranged to be re-used in order to assist in performing integrity checking operations of program code executed by the processor core 10.

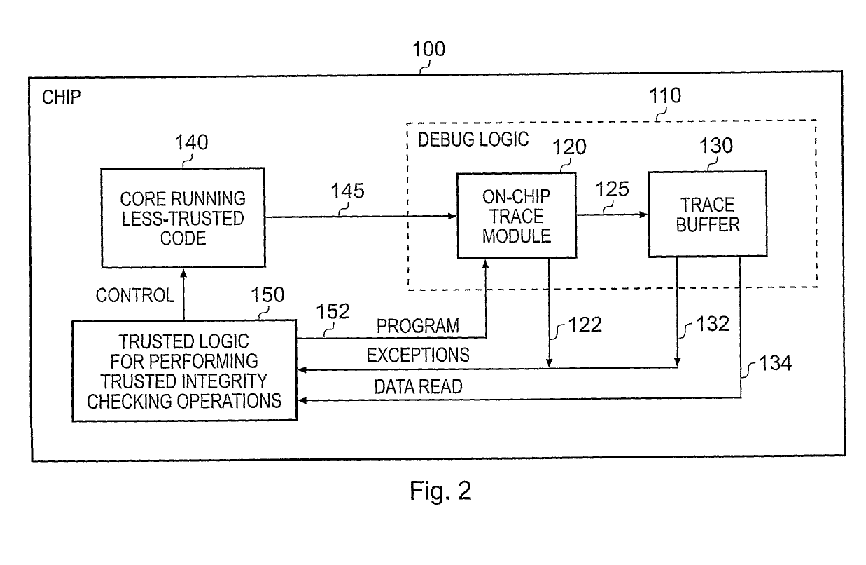

FIG. 2 is a diagram schematically illustrating how the on-chip trace module and associated trace buffer can be re-used in accordance with one embodiment of the present invention to assist in performing such integrity checking operations. In a similar way to the prior art described with reference to FIG. 1, the SoC 100 has a processor core 140 which can output signals over path 145 to debug logic 110, the debug logic comprising on-chip trace module 120 and trace buffer 130. In addition, in accordance with one embodiment of the present invention trusted logic 150 is provided for performing trusted integrity checking operations on less-trusted code being run on the processor core 140. The trusted logic 150 is able to send signals over path 152 to an interface of the on-chip trace module in order to program one or more control registers within the on-chip trace module 120 so as to cause the on-chip trace module to detect one or more activities of the processing logic during execution of the less-trusted program code. The interface to the on-chip trace module via which these control registers are programmed is not accessible by the less-trusted program code.

During running of the less-trusted code, the processor core 140 outputs in the usual way information about the sequence of operations being performed, which are received over path 145 by the on-chip trace module 120. Dependent on how the control registers have been programmed by the trusted logic 150, the on-chip trace module will from this information detect the presence of one or more activities and for each such activity will typically generate a log providing certain details about that activity. This log can be maintained internally within the on-chip trace module 120, or be output over path 125 for storing in the trace buffer 130.

On detection of certain particularly suspect activities (as defined by the trusted logic 150) the on-chip trace module 120 may be arranged to issue an exception signal over path 122 to the trusted logic 150 to cause the trusted logic to invoke certain integrity checking operations in respect of the code being executed on the core 140. Additionally, if the volume of information stored in the trace buffer 130 reaches a predetermined level, the trace buffer 130 may be arranged to issue an exception signal over path 132 to the trusted logic 150 to cause certain integrity checking operations to be performed. In some embodiments such an exception signal may not be issued directly by the trace buffer 130, but may be issued by the on-chip trace module 120 which can be arranged to keep a record of how much data is in the trace buffer.

On receipt of such exception signals, the trusted logic 150 may be arranged to read the contents of the trace buffer 130 over path 134 and to use that data to either decide what integrity checking operations to perform, or indeed may perform the integrity checking operations on that data rather than directly on the code being run on the core 140. Based on the results of the integrity checking operations, the trusted logic may send certain control signals to the core 140. For example, if some suspicious activity is detected, this may cause the processor core 140 to be rebooted. Alternatively, a different action may be taken, such as withholding certain secure services from the core 140.

In addition to reacting to exceptions issued by the debug logic 110, the trusted logic 150 may be arranged periodically to read data out of the trace buffer 130 and to act upon that data by performing certain integrity checking operations.

From FIG. 2, it will be appreciated that instead of using the debug logic 110 for its traditional purpose, namely for reference by a trace analyser 90 during debugging operations, the same hardware logic is now in accordance with embodiments of the present invention used by trusted logic 150 that is used to perform trusted integrity checking operations. By appropriate programming of the on-chip trace module, this provides a very efficient and secure technique for performing run-time integrity checking of the less-trusted code executed on the core 140.

The trusted logic 150 can take a variety of forms. For example, it may be provided by a dedicated core separate to the core 140 running the less-trusted code. Alternatively it may be provided by other dedicated hardware logic external to the core 140. However, in an alternative embodiment of the present invention, the trusted logic 150 is actually provided by a virtual processor core executing on the same hardware as the core 140. In particular, in one embodiment of the present invention, the chip 100 provides separate domains, with these domains providing a mechanism for handling security at the hardware level. Such a system is described for example in commonly assigned co-pending U.S. patent application Ser. No. 10/714,561 which describes a system having a secure domain and a non-secure domain. In accordance with such an approach, the non-secure and the secure domains in effect establish separate worlds, with the secure domain providing a trusted execution space separated by hardware enforced boundaries from other execution spaces, and likewise the non-secure domain providing a non-trusted execution space. In accordance with one such embodiment, the trusted logic may be formed by the processor core when operating in the secure domain.

Irrespective of which domain the processor core is executing in, it will typically be able to operate in a plurality of modes of operation, and many of these modes will be replicated between the different domains. Accordingly, in the secure domain the processor core may be able to operate in secure privileged mode, for example a secure supervisor mode, and may also be able to operate in a secure user mode. Similarly, in the non-secure domain, the processor core may be able to operate in a non-secure privileged mode, for example a non-secure supervisor mode, and may also be able to operate in a non-secure user mode. If the trusted logic 150 is formed by the processor core when operating in a secure privileged mode, then the less-trusted code that can be subjected to the integrity checking operations may be executed by the processor core when operating in any non-secure mode, or indeed by the processor core when executing in secure user mode (or indeed any secure privileged mode which is less trusted that the secure privileged mode in which the trusted logic executes). Similarly, if the trusted logic is formed by the processor core when executing in secure user mode, then the less-trusted code that can be subjected to the integrity checking operations may be code executed by the processor core when running in any non-secure mode.

Similarly, even in a system which does not use multiple domains, and hence in effect only has a non-secure domain, the trusted logic may be formed by the processor core when operating in a privileged mode of operation, and the less-trusted code may be that code executed by the processor core when operating in a user mode, or a less-trusted privileged mode.

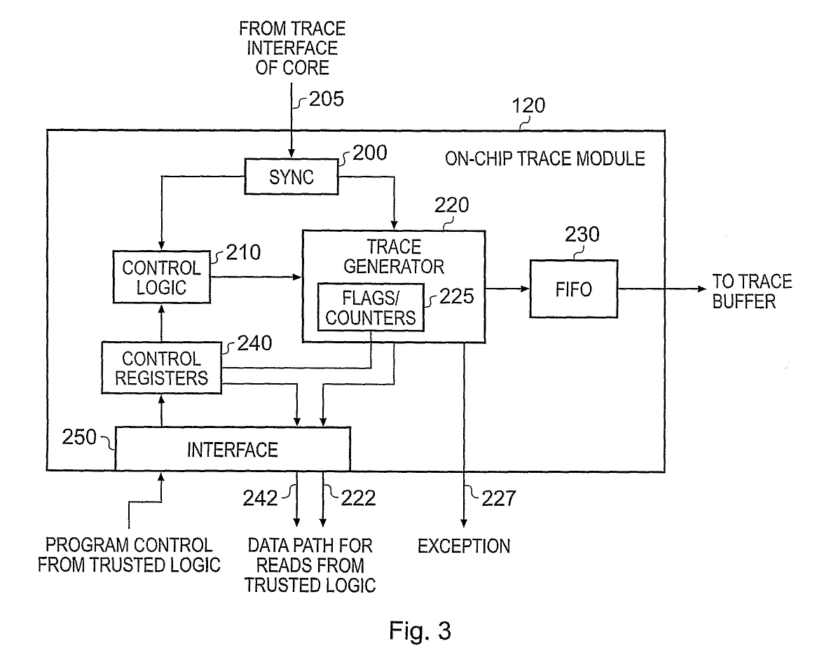

FIG. 3 is a block diagram of the on-chip trace module 120 in accordance with one embodiment of the present invention. The on-chip trace module 120 is arranged to receive over path 205 data indicative of the processing being performed by the processor core 140, this being received over path 145 shown in FIG. 2. The sync logic 200 is arranged to convert the incoming signals into internal versions of the signals more appropriate for use within the on-chip trace module 120. These internal versions are then sent to the control logic 210 and the trace generation logic 220, although it will be appreciated that the control logic 210 and the trace generation logic 220 will not necessarily need to receive the same signals. Fundamentally the control logic 210 needs to receive data relating to triggerable events, for example instruction addresses, data values, register accesses, etc so that it can determine whether the trace generator should be activated, and what types of data should be traced. It then issues appropriate control signals to the trace generation logic 220 to cause the required logs or trace elements to be generated by the trace generation logic 220. The trace generation logic 220 receives via the sync logic 200 any data that would need to be traced dependent on the control signals issued by the control logic 210.

In accordance with embodiments of the present invention, control registers 240 are provided which are used to configure the operation of the control logic 210, and to establish various flags and counters 225 within the trace generator 220. These control registers are programmable by the trusted logic 150 via the interface 250, this interface being arranged not to be accessible by any of the less-trusted code executing on the processor core. In one embodiment, the processor core is arranged when outputting signals to issue a domain ID signal therewith identifying the domain in which the processor core is operating. This domain ID signal may also be referred to as the NS bit, and when the NS bit has a logic zero value this indicates that the processor core is operating in the secure domain. In such embodiments, the interface 250 can be arranged to only accept program control signals that are issued by the processor core and are accompanied by an NS bit having a logic zero value, indicating that the processor core is operating in the secure domain.

As also shown in FIG. 3, the trace generator 220 is able to issue an exception signal over path 227 for routing to the trusted logic 150 in order to invoke the trusted integrity checking operations, as discussed earlier with reference to FIG. 2. Further, the trusted logic 150 can read over paths 222, 242 data held within the control registers 240 and/or the flags/counters 225, which can be referenced when performing any such trusted integrity checking operations.

When the trace generator 220 determines that information in the form of a log or one or more trace elements needs to be output to the trace buffer, it outputs that information to the FIFO buffer 230, from where it is then output to the trace buffer 130.

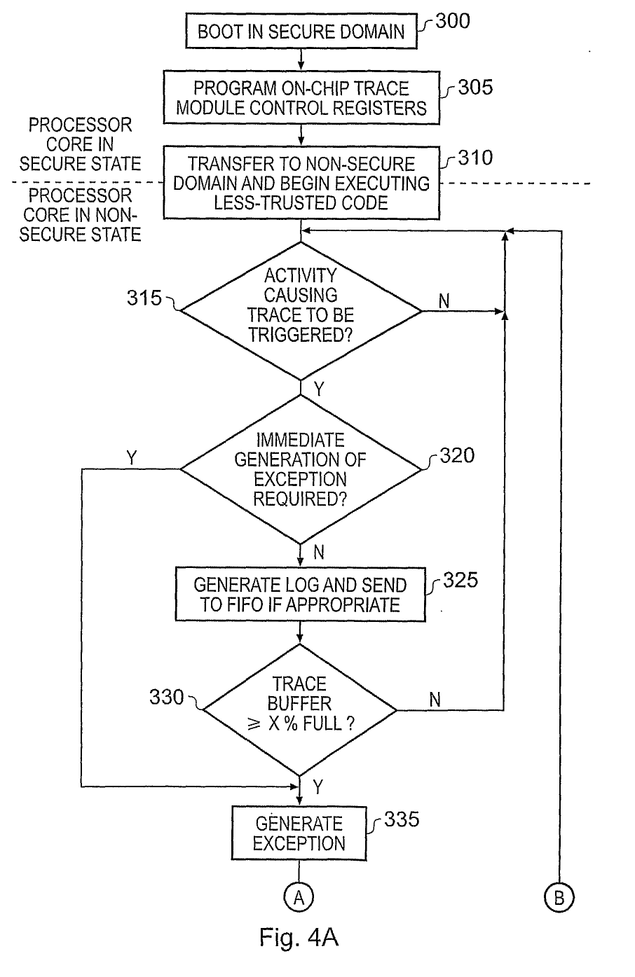

FIGS. 4A and 4B are flow diagrams illustrating the general process performed in accordance with an embodiment of the present invention to perform trusted integrity checking operations dependent on activities traced by the on-chip trace module 120. In this embodiment, it is assumed that the trusted logic 150 is implemented by the processor core when executing in the secure domain, and in particular by the processor core when executing in a particular secure mode of operation within the secure domain, for example a predetermined secure privileged mode of operation. At step 300, the processor core boots in the secure domain, and thereafter at step 305 the processor core executing in a particular secure mode of operation programs the on-chip trace module 120 by sending appropriate signals over path 152 to the interface 250, and from there to the control registers 240 of the on-chip trace module 120 illustrated in FIG. 3.

In particular, in one embodiment, at step 305, the on-chip trace module 120 will be programmed to identify particular regions of memory that it should monitor for accesses to. These regions of memory may be regions containing instructions and/or regions containing data. For example some data regions will contain jump tables, vector tables, and the like referenced by the operating system, and such data regions are often subjected to semantic checks. Hence, the on-chip trace module may be arranged to monitor such data regions for modifications (i.e. data writes), so that the trusted logic 150 can be alerted to such data writes and take any appropriate action. The control registers will also typically include certain enable and disable registers to enable or disable certain tracing functionality. In addition, the trusted logic may during this programming step input data to the control registers 240 which is used to set certain flags and counters 225 within the trace generator 220. In one embodiment, a separate flag and/or counter may be provided in association with each region that is to be monitored. For example the flag/counters may be used to record/count instruction fetches in an address range, to record/count data reads in an address range, and/or to record/count data writes in an address range. One type of flag that may be associated with each region to be monitored is a security level flag, which dependent on its setting will identify whether accesses to the associated memory region merely need to be logged or traced, or whether instead an exception signal should be generated immediately by the trace generation logic 220 upon detection of an access to that memory region. Hence, by setting the security level flag to indicate that an exception should be generated, accesses to particularly sensitive memory regions can be alerted to the trusted logic 150 without delay.

The counters associated with each region to be monitored may be used in a variety of ways. For example, in some situations it may be desirable to know the number of times that a particular memory region has been accessed, with the counter keeping track of that number, or alternatively it may be of interest only to know that the memory region has been accessed at all, and it may not be overly relevant how many times that region has been accessed. Counters can be maintained by the trace generator 220 in order to reduce the amount of information that needs to be traced, for example by avoiding the need to output trace information each time a memory region is accessed, or by providing information that can enable some ordering of the information as stored within the trace buffer 130, for example by overwriting some previous trace information with the updated trace information including an updated counter value.

In addition to the control registers 240 storing information about the memory address regions to be watched, certain filters can also be specified in the control registers to identify what subset of instruction and data activity is to be logged for accesses that occur within those memory regions, for example identifying that the program counter (PC) source and destination should be recorded on entry to a sensitive code range.

Following the programming of the on-chip trace module control registers at step 305, the processor core transfers from the secure domain/state to the non-secure domain/state, and begins executing the less-trusted code, in this embodiment the less-trusted code being code executed in the non-secure domain.

At step 315, the on-chip trace module 120 determines from the information it receives from the processor core 140 whether an activity has been detected which should cause trace to be triggered. This decision is performed with reference to the control registers 240, and in particular the control registers identifying the memory regions of interest. If it is determined that trace should be triggered, then at step 320 it is determined whether immediate generation of an exception is required, this being performed by the trace generator 220 with reference to the flag/counters 225. In particular, the trace generator 220 references the earlier-mentioned security level flag for the memory region in question, the control logic 210 providing an indication of the memory region in association with the trigger signal sent from the control logic to the trace generator to turn trace on.

If an immediate generation of an exception is required, the process branches from step 320 to step 335, where the exception is generated. However, if immediate generation of an exception is not required, the process proceeds to step 325 where a log is generated for the memory region in question and sent to the FIFO 230 if appropriate. In some embodiments, the trace generator may be arranged to output the log each time it is updated, whereas in other embodiments the trace generator 220 may be arranged to output the log only periodically.

At step 330, it is determined whether the trace buffer is more than a certain percentage full, and if not the process returns to step 315 to monitor further activities. However, if the trace buffer is more than a certain percentage full, then the process proceeds to step 335 where an exception is generated, this exception being generated either by the trace buffer 130 or by the on-chip trace module 120 based on its knowledge of the contents of the trace buffer.

Thereafter the process proceeds to step 340, where the handling of the exception causes the processor core to transfer from the non-secure domain to the secure domain. Thereafter, the trusted logic 150, which in this case is implemented by code executing in a particular secure mode, analyses the trace data by reading the required data from the trace buffer 130 and performing certain integrity checking operations. Based on the information contained therein, it is determined whether there has been an integrity violation, and if not the process proceeds to step 355, where the processor core transfers from the secure state to the non-secure state, whereafter the process returns to step 315.

However, if at step 350 the various integrity checking operations performed by the trusted logic 150 when analysing the trace data at step 345 indicate that there has been an integrity violation, then required action is taken at step 360.

This required action can take a variety of forms. For example, for some integrity violations, it may be appropriate to reboot the processor core. However, for some violations, this may not be needed, and instead the action may involve withdrawing certain services from the processor core. In particular, considering a processor core that can operate in the secure domain and the non-secure domain, code executing in the secure domain can be used to perform certain sensitive operations, with these sensitive operations being performed as a service for certain non-secure applications. An example of such secure operations that can be performed in the secure domain is cryptographic key management operations. Such operations may be involved when performing Digital Rights Management (DRM) of media, for example music, when performing micro-payments, when securely booting a mobile phone whilst it is logging onto a network, etc. Non-secure applications can request some of these operations to be performed by the secure domain on their behalf. If the integrity checking operations performed on the non-secure code indicates that there may be an integrity violation, then one step that can be taken at step 360 is to withdraw such cryptographic key management services from the non-secure application, thereby disabling certain functionality.

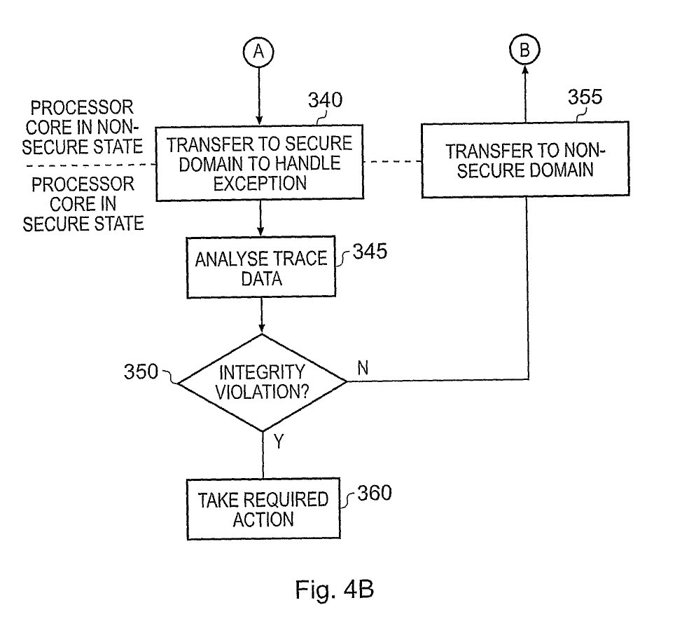

FIG. 5 is a flow diagram illustrating the operation of the control logic 210 within the on-chip trace module 120 of FIG. 3 in accordance with one embodiment. At step 400, the control logic determines based on the signals it receives from the sync logic 200 whether an access has occurred to a region of interest. As mentioned earlier, this will typically be performed with reference to the control registers 240 that have been programmed by the trusted logic 150. If access to a region of interest is determined, then the control logic 210 will assert a trigger to the trace generator 220 along with a region ID signal. Then, at step 420 it is determined whether access to the region of interest has exited, and if not the trigger continues to be asserted. However, once access to the region of interest has been exited, then the trigger is de-asserted, along with de-assertion of the region ID signal, at step 430. Thereafter, the process returns to step 400.

Depending on the size of the regions of interest that have been defined, it will be appreciated that the trigger may be asserted for a small amount of time or for a relatively large amount of time. If the trusted logic is being used to perform certain heuristic checks, then the regions defined are likely to be relatively small, for example identifying only one or a few instructions in each region, and accordingly in such instances the trigger from the control logic may be asserted for a relatively small amount of time.

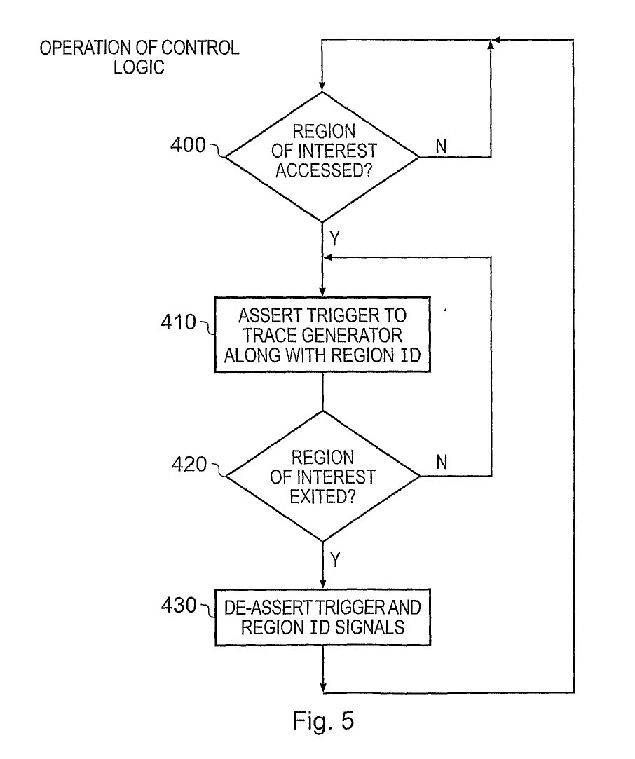

FIG. 6 is a flow diagram illustrating the operation of the trace generator 220 of FIG. 3 in accordance with one embodiment. At step 500, it is determined whether a trigger has been asserted from the control logic 210, and if so the process proceeds to step 505, where the flags and counters 225 associated with the relevant region, as indicated by the region ID signal issued by the control logic, are reviewed. In particular, at step 510, it is determined whether the security flag is set, and if so an exception is generated over path 227 at step 515. Thereafter, the process proceeds to step 520, or proceeds directly from step 510 to step 520 in the event that the security flag is not set.

At step 520, it is determined whether for the memory region in question it is appropriate to perform a full trace or instead to generate a log of information. The information identifying whether either a full trace or a log need to be generated will in one embodiment be stored within one of the control registers 240, or as one of the flags 225. If full trace is required, then the process proceeds to step 525, where one or more trace elements are generated for outputting to the FIFO 230, these trace elements providing details of the activity being performed by the processor core. These generated trace elements are output to the FIFO at step 530, whereafter the process returns to step 500.

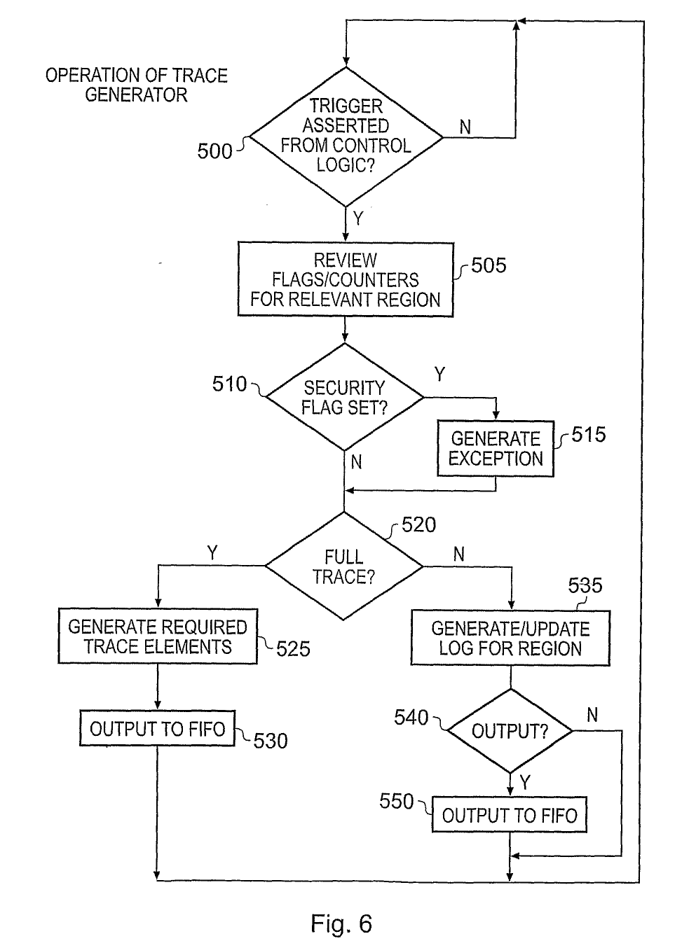

However, if at step 520 it is determined that a full trace is not required, then the process proceeds to step 535 where a log is generated for the region in question. This log may take a variety of forms, and indeed one form of log will be discussed further later with reference to FIG. 7. The purpose of the log is to provide certain key information about the activities in respect of the memory region in question which can later be used to influence the integrity checking operations performed by the trusted logic. A separate log may be generated for each access, or instead a log may be updated each time an access to a particular region occurs, with the updated log superseding any previously generated version. As mentioned earlier, when updating logs, the updated log may be output each time to the FIFO 230 and from there to the trace buffer, with the trace buffer then overwriting a previous version of the log within the trace buffer, or alternatively the updated log may be retained within the trace generator 220 (for example by updating the flags and/or counters 225, and optionally also the control registers 240) and only output periodically to the FIFO 230 and trace buffer 130. Accordingly, at step 540, it is determined whether the generated/updated log should be output, and if not the process returns directly to step 500. However, if it is determined that the log should be output, then that log is output to the FIFO 230 at step 550. Thereafter the process returns to step 500.

As an example of where the full trace option indicated by steps 525, 530 may be used, such an approach may be appropriate for memory region accesses that are of interest to dynamic semantic/heuristic checks. It will be appreciated that the trace elements generated at step 525 can be generated using standard trace generation techniques, and may employ one or more known trace compression techniques.

The alternative approach of generating a log for the particular region accessed will often be appropriate for access to memory regions that are used for static cryptographic hashing checks, although indeed such logs may also be used for accesses to memory regions used for the semantic/heuristic checks.

FIG. 7 illustrates an example of a log that may be generated for each memory region being monitored. The log 560 will contain a number of fields, and may for example contain a field 570 identifying the size of the log. Alternatively, if all logs generated are of the same size, then this field may be omitted. An additional field 575 identifies the region identifier, and hence associates the log with a particular memory region being accessed. The further field 580 then indicates the current access count as maintained by the counter 225 for the appropriate memory region, and field 585 provides the current state of the flags 225 associated with that memory region. As mentioned earlier, one such flag will be the security level flag, which enables just-in-time checking to be performed by causing accesses to particularly sensitive memory regions to be alerted to the trusted logic 150 without delay. The security flag could be analysed in combination with some form of counter, so that for example an exception is triggered only once every n-th access, rather than on every access. As will be understood by those skilled in the art, the exact choice of flags used will depend on the type of checking being performed, and hence for example if advanced statistical checking is being performed the flags will be used in combination with the counters and control registers to model the software that the less-trusted mode(s) is actually executing.

Dependent on how the logs are being used, and in particular which types of integrity checks are going to make reference to those logs, it will be appreciated that the information maintained in the logs can be varied. For example, for some integrity checks, it may only be necessary to identify the first access to a memory region, and accordingly the access count information may not be required.

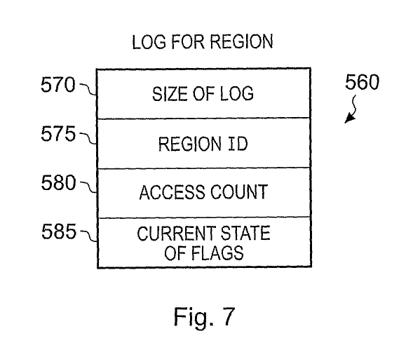

As discussed earlier, in one embodiment the processor core is operable in either a secure domain or a non-secure domain. In one such embodiment, the processor core is operable to execute monitor code in order to transition from one domain to another. The operation of such a processor core is described in detail in the earlier-mentioned co-pending U.S. patent application Ser. No. 10/714,561. FIGS. 8 to 11 are provided to indicate an overview of the operation of such a processor core, and the reader is referred to the above-mentioned US patent application for further details.

FIG. 8 schematically illustrates various programs running on a processing system having a secure domain and a non-secure domain. The system is provided with a monitor program 620 which executes at least partially in a monitor mode. The monitor program 620 is responsible for managing all changes between the secure domain and the non-secure domain in either direction. From a view external to the core the monitor mode is always secure and the monitor program is in secure memory.

Within the non-secure domain there is provided a non-secure operating system 610 and a plurality of non-secure application programs 612, 614 which execute in co-operation with the non-secure operating system 610. In the secure domain, a secure kernel program 600 is provided, and the secure kernel program 600 can be considered to form a secure operating system. Typically such a secure kernel program 600 will be designed to provide only those functions which are essential to processing activities which must be provided in the secure domain such that the secure kernel 600 can be as small and simple as possible since this will tend to make it more secure. A plurality of secure applications 602, 604 are illustrated as executing in combination with the secure kernel 600.

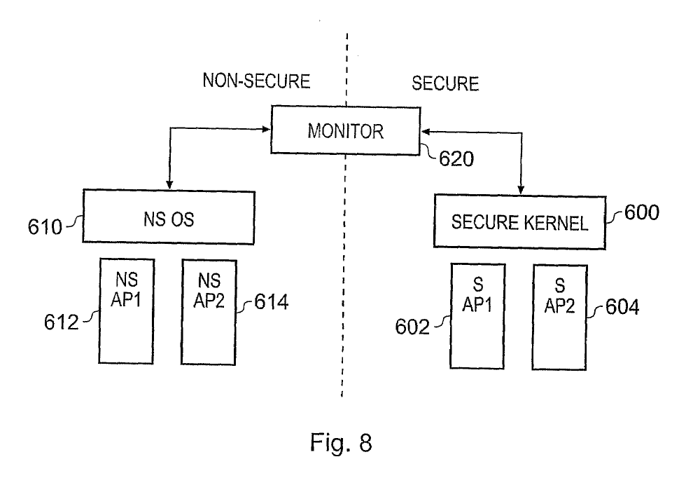

FIG. 9 illustrates a matrix of processing modes associated with different security domains. In this particular example the processing modes are symmetrical with respect to the security domain and accordingly mode one and mode two exist in both secure and non-secure forms.

The monitor mode has the highest level of security access in the system and in this example embodiment is the only mode entitled to switch the system between the non-secure domain and the secure domain in either direction. Thus all domain switches take place via a switch to the monitor mode and the execution of the monitor program 620 within the monitor mode.

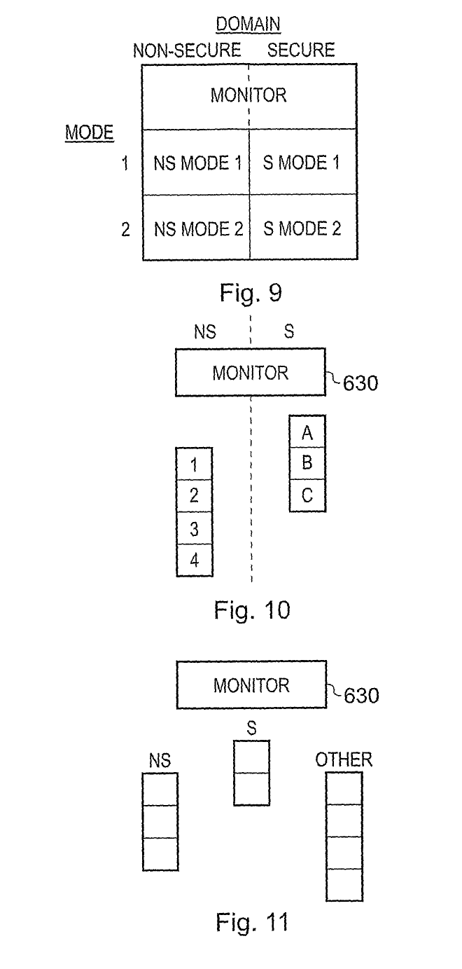

FIG. 10 schematically illustrates another set of non-secure domain processing modes 1, 2, 3, 4 and secure domain processing modes A, B, C. In contrast to the symmetric arrangement of FIG. 9, FIG. 10 shows that some of the processing modes may not be present in one or other of the security domains. The monitor mode 630 is again illustrated as straddling the non-secure domain and the secure domain. The monitor mode 630 can be considered a secure processing mode, since a secure status flag may be changed in this mode. Hence, it effectively provides the ultimate level of security within the system as a whole.

FIG. 11 schematically illustrates another arrangement of processing modes with respect to security domains. In this arrangement both secure and non-secure domains are identified as well as a further domain. This further domain may be such that it is isolated from other parts of the system in a way that it does not need to interact with either of the secure domain or non-secure domain illustrated.

From the above description of an embodiment of the present invention, it will be appreciated that such embodiments make the process of run-time integrity checking on executing software more efficient, and in one particular embodiment provide a cost-effective solution by taking advantage of a processor core's secure execution space as provided by a secure domain described earlier, along with existing core debug hardware. By such an approach, efficient checking of code and data that is being used by the processor core can be performed, either in a “just-in-time” fashion, or in a more advanced statistical mode.

Just-in-time checking is when the entering of a critical section by the less-trusted software is detected, and then a switch to the trusted integrity checking operations takes place to perform the validation of the critical section before it executes. This is efficient because only the software that the Normal World is actually executing needs to be checked and the rest can be ignored. Such an approach can be implemented through use of the earlier mentioned security level flag.

“Advanced statistical mode” checking is where the flags, counters and control registers are used to model the software that the less-trusted mode(s) is actually executing, and the checks are performed in a manner appropriate to the model.

One particular processor core which provides the earlier-mentioned secure and non-secure domains is a core constructed using ARM Limited's TrustZone architectural features, but it will be appreciated from the earlier discussions that embodiments of the present invention can also be employed in connection with other types of processor core.

In accordance with embodiments of the present invention, the on-chip trace module is shared between the run-time integrity checking software and the more traditional debug agent/trace analyser tool. This sharing process needs to be managed, but can be designed into the trusted software, allowing the run-time trusted logic to be turned off when traditional software tracing is required. In the above described embodiment, this would also have the consequence that security services running in the secure domain will typically stop providing those services if they were relying on the run-time integrity checking to enforce some level of security in the non-trusted domain.

In accordance with the above described embodiments, the on-chip trace module is provided with extended configurability, extended internal functions, and a secure software interface. This enables trusted integrity checking code executing in the secure domain to police the instruction and data activity of the less-trusted code executing in the non-secure domain. The extensions may include, but are not limited to, the addition of flags/counters to record/count instruction fetches in an address range, to record/count data reads in an address range, and to record/count data writes in an address range. Further, filters can be specified in the control registers to identify what subset of instruction and data activity is logged. In addition, hardware rules, which are secure-software configurable, may be applied to the above flags and counters in order to determine whether to trigger a secure-software exception as discussed earlier. From the earlier discussions, it will also be appreciated that the trusted integrity checking operation code can configure, reset and retrieve information from the on-chip trace module and associated trace buffer for use in performing the integrity checking operations on the less-trusted code.

The above features of embodiments of the present invention provide the following functionality. Firstly, they can improve the robustness of semantic checks. Semantic checks of code are normally managed via invasive software patches, which malicious software can work around. By allowing the trace logic hardware to monitor and record key points of execution, the need to invasively modify the software being monitored is removed. This increases the security of the system, provided access to the on-chip trace module and associated trace buffer is only allowed by the trusted software when it is being used for run-time integrity checking. The order of execution of code or data regions could also be logged by the trace module hardware, and hence the less-trusted code can execute at full speed despite the fact that data logging is being performed for semantic checking processes.

Semantic checks often apply to non-static data regions (for example jump tables or vector tables), and so the ability to monitor these regions for modifications is very important. The secure integrity checking code can then take appropriate action when a bad data write to a key table is detected.

The above features of embodiments of the present invention also provide improved performance for static integrity checks. In particular, the trusted integrity checking code can generate a statistical model of what has been running in the non-secure domain, and adjust heuristics controlling what to check and how often it will need checking—some integrity checking is a statistical process. This enables the software to reduce the overall amount of hash checking required.

Additionally, security-critical regions of code can be configured to be automatically checked when they are entered (by use of the earlier mentioned exception signals), and hence before they are executed. The trusted integrity checking code could apply heuristics, for example under secure timer control, to enable and disable this feature to trade off between security and execution overhead.

The above described embodiment of the present invention is also highly configurable. The trusted integrity checking code that configures the control registers within the trace logic and performs the checks can be written to suit a specific piece of less-trusted software code, which hence makes the overall system very configurable by the end customer.

Embodiments of the present invention also exhibit power saving advantages over the known prior art. In particular, run-time integrity checking is a difficult process, and in typical prior art systems often results in precautionary checks which may not be required. By enabling run-time code analysis using the earlier described techniques of embodiments of the present invention, heuristics can be applied to focus on code that is executing, thereby improving performance and reducing power use.

Although a particular embodiment has been described herein, it will be appreciated that the invention is not limited thereto and that many modifications and additions thereto may be made within the scope of the invention. For example, various combinations of the features of the following dependent claims could be made with the features of the independent claims without departing from the scope of the present invention.

1. A data processing apparatus comprising:
a processing unit operable to execute program code;
debug logic for use when debugging the program code executed by the processing unit;
trusted logic operable to perform trusted integrity checking operations on less-trusted program code executed by the processing unit;
the debug logic having an interface via which one or more control registers associated with the debug logic are programmable by the trusted logic, the interface not being accessible by the less-trusted program code;
the trusted logic being operable to program the one or more control registers to cause the debug logic to be re-used to detect one or more activities of the processing logic during execution of said less-trusted program code;
the trusted integrity checking operations performed by the trusted logic being influenced by the activities detected by the debug logic.

2. A data processing apparatus as claimed in claim 1, wherein upon occurrence of one or more predetermined conditions the debug logic is operable to issue a signal to the trusted logic to cause one or more of said trusted integrity checking operations to be performed.

3. A data processing apparatus as claimed in claim 2, wherein at least one of said one or more predetermined conditions is the detection of a predetermined activity of the processing logic by the debug logic.

4. A data processing apparatus as claimed in claim 2, wherein the debug logic is operable to maintain information about the activities detected and one of said one or more predetermined conditions is a volume of said maintained information reaching a threshold value.

5. A data processing apparatus as claimed in claim 1, wherein the debug logic is operable to maintain information about the activities detected, said maintained information being used by the trusted logic to determine which of said trusted integrity checking operations to perform.

6. A data processing apparatus as claimed in claim 1, wherein the debug logic is operable to maintain information about the activities detected, said trusted integrity checking operations being performed on the maintained information.

7. A data processing apparatus as claimed in claim 1, wherein said debug logic comprises trace generation logic for producing a stream of trace elements indicative of activities of the processing logic for use when debugging the program code executed by the processing logic, the trusted logic being operable to re-use the trace generation logic to maintain information about said one or more activities detected during execution of the less-trusted program code by the processing logic, said maintained information being used to influence the trusted integrity checking operations performed by the trusted logic.

8. A data processing apparatus as claimed in claim 7, wherein said debug logic further comprises a trace buffer into which said maintained information is stored.

9. A data processing apparatus as claimed in claim 7, wherein said maintained information comprises a log for each of said one or more activities detected.

10. A data processing apparatus as claimed in claim 1, wherein at least one of said one or more activities comprises access by the processing logic to a specified memory address range programmed into the one or more control registers by the trusted logic.

11. A data processing apparatus as claimed in claim 1, wherein the data processing apparatus has a plurality of domains in which devices of the data processing apparatus can execute, the processing logic being operable in a non-secure domain to execute said less-trusted program code, and the trusted logic being operable in a secure domain to perform said trusted integrity checking operations.

12. A data processing apparatus as claimed in claim 11, wherein said processing logic is further operable in said secure domain, and said trusted logic is formed by said processing logic executing trusted integrity checking code in said secure domain.

13. A data processing apparatus as claimed in claim 12, wherein said processing logic is operable in a plurality of modes, including at least one non-secure mode being a mode in the non-secure domain and at least one secure mode being a mode in the secure domain.

14. A data processing apparatus as claimed in claim 13, wherein in said non-secure domain said processing logic is operable under the control of a non-secure operating system, and in said secure domain said processing logic is operable under the control of a secure operating system.

15. A data processing apparatus as claimed in claim 1, wherein the processing logic is operable in a plurality of modes, the processing logic being operable in at least one less-trusted mode to execute said less-trusted program code, and the trusted logic being operable in a trusted mode to execute trusted integrity checking code.

16. A data processing apparatus as claimed in claim 15, wherein said trusted mode is at least one privileged mode.

17. A data processing apparatus as claimed in claim 15, wherein the data processing apparatus has a plurality of domains in which devices of the data processing apparatus can execute, said plurality of modes comprising at least one non-secure mode being a mode in the non-secure domain and at least one secure mode being a mode in the secure domain.

18. A data processing apparatus as claimed in claim 17, wherein said trusted mode is at least one of said at least one secure modes.

19. A data processing apparatus as claimed in claim 18, wherein said at least one less-trusted mode comprises at least one non-secure mode.

20. A data processing apparatus as claimed in claim 15, wherein said trusted logic is formed by said processing logic executing in said trusted mode.

21. A data processing apparatus as claimed in claim 1, wherein said trusted logic is provided by a separate processor to the processing logic.

22. A data processing apparatus comprising:
processing means for executing program code;
debug means for use when debugging the program code executed by the processing means;
trusted means for performing trusted integrity checking operations on less-trusted program code executed by the processing means;
the debug means having interface means via which one or more control register means associated with the debug means are programmable by the trusted means, the interface means not being accessible by the less-trusted program code;
the trusted means programming the one or more control register means to cause the debug means to be re-used to detect one or more activities of the processing means during execution of said less-trusted program code;
the trusted integrity checking operations performed by the trusted means being influenced by the activities detected by the debug means.

23. A method of operating a data processing apparatus to perform integrity checking operations, the data processing apparatus having a processing unit for executing program code, and debug logic for use when debugging the program code executed by the processing unit, the method comprising the steps of:
employing trusted logic to perform trusted integrity checking operations on less-trusted program code executed by the processing unit;
programming one or more control registers of the debug logic via an interface which is not accessible by the less-trusted program code, said programming causing the debug logic to be re-used to detect one or more activities of the processing logic during execution of said less-trusted program code; and
performing the trusted integrity checking operations dependent on the activities detected by the debug logic.
